(19) United States
(12) Patent Application Publication
(10) Pub. No.: US 2021/0259282 A1
(43) Pub. Date: Aug. 26, 2021

(54) PROCESS FOR THE PURIFICATION OF WHEY PROTEIN ISOLATE AND FORMULATION THEREOF

(71) Applicant: SMART MEDICINES GMP INC., Laval (CA)

(72) Inventors: Domenico FUOCO, Montreal (CA); Jonathan COHEN, Dollard-Des-Ormeaux (CA); Luis Michel Alfonso MARTINEZ, Montreal (CA)

(21) Appl. No.: 16/923,543

(22) Filed: Jul. 8, 2020

Related U.S. Application Data
(60) Provisional application No. 62/979,123, filed on Feb. 20, 2020.

(51) Int. Cl. A23J 1/20; A23L 33/175; A23C 21/08; A23C 9/142

(52) U.S. Cl. CPC A23J 1/205; A23L 33/175; A23V 2002/00; A23C 9/1425; A23C 21/08

(57) ABSTRACT

The present document describes a process for the preparation of an amino acid supplement formulation and a formulation thereof. The process comprises filtering a clarified whey protein solution with a filter having a molecular weight cut off between about 50 and 300 kDa to obtain a protein solution; dehydrating the protein solution to obtain a powder; and mixing the powder with lecithin. The present document also describes a process for the purification of a whey protein isolate, comprising filtering a clarified whey protein solution with a filter having a molecular weight cut off between about 50 and 300 kDa to obtain a protein solution; and filtering the protein solution with a filter having a molecular weight cut off between about 1 and 100 kDa to obtain a protein solution having at least one of active albumin, beta-lactoglobulin, and alpha-lactalbumin proteins.

### BACKGROUND

### (a) Field

The subject matter disclosed generally relates to a process for the purification of whey protein isolate and preparation of an amino acid formulation containing the whey protein isolate.

### (b) Related Prior Art

The proteins present in milk, whey, colostrum, and other compositions produced from lactating animals are of value for their nutritional and functional properties. These proteins are generally categorized into two classes. The first class is a heterogenous mixture called casein and represents approximately 80% of the proteins found in milk compositions. The second class is a heterogenous mixture called whey proteins including the remaining 20% of the proteins in milk.

These proteins may be separated from milk, whey, colostrum, and other related compositions using a variety of chemical and physical processing techniques. The isolation of these proteins has however proven complicated and difficult. The proteins in order to retain their activity must not be denatured during the purification process and thus harsh treatments such as heat or lengthy exposure to strong acid must generally be minimised or avoided. For these reasons, isolation of milk proteins has been centered around the concepts of mild chemical treatments, filtration (e.g. by reverse osmosis, diafiltration, ultrafiltration, and microfiltration) and ion exchange techniques, or a combination of these techniques.

For example, U.S. Pat. No. 6,139,901 describes a process of enhanced separation of small molecular weight and large molecular weight components of milk by adding alkali to adjust the pH above the natural pH of milk and below about pH 10 followed by heating the composition. Thereafter the composition is cooled and ultrafiltrated and diafiltrated at near neutral pH or slightly acidic pH.

U.S. Pat. No. 7,378,123 discloses a method based on a cation exchange support for preparing whey proteins that are substantially nondenatured across a range of pH, including their isoelectric points.

However, the processes and methods known to date for the separation or purification of whey proteins remain tedious to implement on a large scale, such as in the context of an industrial application. Further, these processes and methods are generally expensive to operate and may only provide for about 80% purity. These techniques also change the protein profile of the resulting isolate so that it no longer mimics that of the original milk product.

There is therefore a need for a process for the purification of whey protein isolate that is cost-effective as well as easy to implement and operate on a large scale. There is also a need for a process for the purification of whey protein isolate that produce substantially high-purity and substantially undenatured whey protein isolate which closely match the protein profile of the starting material. There is further a need for the preparation of an amino acid formulation containing the purified whey protein isolate.

### SUMMARY

According to an embodiment, there is provided a process for the preparation of an amino acid supplement formulation, which comprises:
a) filtering a clarified whey protein solution with a filter having a molecular weight cut off between about 50 kDa and about 300 kDa to obtain a protein solution substantially free of IgA, IgG, IgM, lactoperoxidase, and lactoferrin;
b) dehydrating the protein solution to obtain a branched-chain amino acid powder; and
c) mixing the branched-chain amino acid powder with lecithin.

According to another embodiment, there is provided an amino acid supplement formulation obtained according to the process for the preparation of an amino acid supplement formulation disclosed herein.

According to another embodiment, there is provided a process for the purification of a whey protein isolate, which comprises:
a) filtering a clarified whey protein solution with a filter having a molecular weight cut off between about 50 kDa and about 300 kDa to obtain a protein solution substantially free of IgA, IgG, IgM, lactoperoxidase, and lactoferrin; and
b) filtering the protein solution with a filter having a molecular weight cut off between about 1 kDa and about 20 kDa to obtain a protein solution having concentrate active albumin, beta-lactoglobulin, and alpha-lactalbumin proteins.

According to another embodiment, there is provided a process for the purification of a whey protein isolate, which comprises:
a) filtering a clarified whey protein solution with a filter having a molecular weight cut off between about 50 kDa and about 300 kDa to obtain a protein solution substantially free of IgA, IgG, IgM, lactoperoxidase, and lactoferrin; and
b) filtering the protein solution with a filter having a molecular weight cut off between about 10 kDa and about 100 kDa to obtain albumin protein.

According to another embodiment, there is provided a process for the purification of a whey protein isolate, which comprises:
a) filtering a clarified whey protein solution with a filter having a molecular weight cut off between about 50 kDa and about 300 kDa to obtain a protein solution substantially free of IgA, IgG, IgM, lactoperoxidase, and lactoferrin;
b) filtering the protein solution with a filter having a molecular weight cut off between about 1 kDa and about 20 kDa to obtain a alpha-lactalbumin and beta-lactoglobulin solution; and
c) filtering the alpha-lactalbumin and beta-lactoglobulin solution with a filter having a molecular weight cut off between about 1 kDa and about 20 kDa to obtain alpha-lactalbumin and beta-lactoglobulin proteins.

The following terms are defined below.

The term “mammal” is intended to mean any animal that may produce milk (i.e. lactating animal) and include, but is not limited to, cows, goats, sheep, camels, donkey.

The term “purification”, “isolation”, and “extraction” are intended to mean the separation of a substance mixture into the components thereof and may include the removal of impurities from the substance mixture.

The term “filtration” is intended to mean the physical, biological or chemical operation that separate a solid from a fluid (i.e. liquids or gases), which are both present in a mixture, using a filter medium that allows the fluid to pass through but not the solid.

The term “proteins” is intended to mean any large biomolecules, or macromolecules, consisting of one or more long chains of amino acid residues joined by peptide bonds (e.g. enzymes, hormones, or antibodies).

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 illustrates a block diagram of a process for the purification of whey protein isolate from colostrum, according to an embodiment of the present invention;

FIG. 2 is a HPLC chromatogram illustrating an elution profile of crude colostrum as starting material for the process for the purification of whey protein isolate;

FIG. 3 is a HPLC chromatogram illustrating an elution profile of an Ig fraction obtained from the process for the purification of whey protein isolate; and

It will be noted that throughout the appended drawings, like features are identified by like reference numerals.

### DETAILED DESCRIPTION

In embodiments, there are disclosed a process for the purification of whey protein isolates (WPI) from milk, lactoserum, colostrum, and/or other compositions produced from lactating animals that is adapted for large scale production and/or industrial applications. Particularly, the process is based on the molecular weight differences between the various components of milk in order to obtain purified whey protein isolates. According to this process, milk and/or colostrum of any mammal may be used. Preferably, bovine colostrum is used. Still according to this process, whey proteins may be isolate or purified from colostrum to produce whey protein isolates that are substantially lactose free, carbohydrate free, fat free, and cholesterol free.

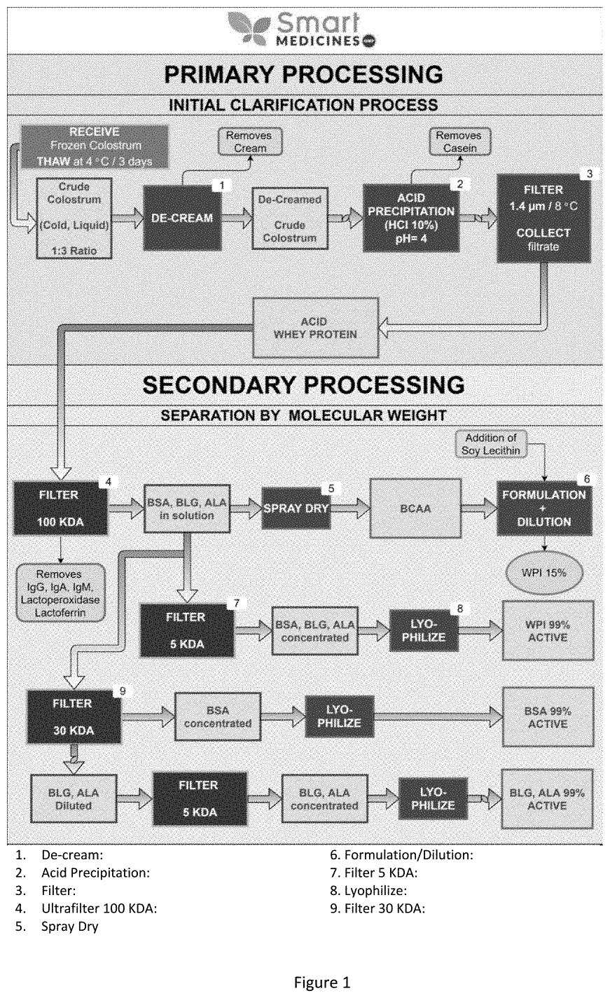

Referring now to the drawings, and more particularly to FIG. 1, a block diagram illustrates the purification process of whey protein isolates disclosed herein, which includes a primary clarification processing (steps 1 to 4) and a secondary separation processing (steps 5 to 13). Particularly, the primary clarification processing includes the steps of: removing a cream from the colostrum (a process also known as “de-creaming”; step 1); acidifying the colostrum (step 2), and removing casein from the colostrum by an acid precipitation and filtration process (step 3); and colleing the filtrate having acid whey protein (step 4).

For its part; the secondary separation processing includes various separation possibilities each one including: removing from an acidified clarified whey protein solution some components thereof according to their molecular weights (step 5); at least one further step of removing from a whey protein isolate solution some components thereof according their molecular weights (steps 8, 10, and 12); dehydrating a whey protein isolate filtrate (steps 6, 9, 11, and 13); and optionally formulating dried whey protein isolates (step 7).

The various steps of the secondary separation processing serve to separate or isolate the various components of the colostrum based on their molecular weights in order to obtains substantially pure whey protein isolate.

As for the primary clarification processing, liquid or frozen colostrum may be used as starting material. When frozen colostrum is used, the colostrum is left between about 10° C. and about 1° C. to thaw for a period of time between about 1 day and about 3 days. Preferably, the frozen solid colostrum is left to thaw at 4° C. for about 3 days.

Then, liquid colostrum is diluted with a solvent, such as purified water, in a ratio of colostrum to solvent between 1:2 (w:w) and 1:4 (w/w), respectively. Preferably, a ratio of colostrum to osmotically-purified water of 1:3 (w/w) is used to obtain a final concentration of 5 to 10% (w/w) crude whey protein isolates. The resulting diluted colostrum solution is then stirred to ensure proper dilution of the colostrum into the solvent, while taking care of keeping the presence of bubbles to a minimum since bubbles may be detrimental to the purification process. In order to facilitate the dilution and minimize the formation of bubbles, the thawed, concentrated colostrum may be itself mixed prior to the dilution. The mixing of the colostrum may be performed according to any means known in the art, such as by hand using a paddle and/or with a mixer or agitator Preferably, hand mixing is used to minimize the formation of bubbles in diluted colostrum. Also, mixing is generally less likely to be needed when the colostrum has been thawed for more than three days at 4° C.

While the colostrum used in the present purification process is in a liquid form, the colostrum may also be in a solid form, such as lyophilized colostrum. In this case, the solid colostrum needs to be dissolved in a manner similar to what is described above for dilution of liquid colostrum prior to be used by present purification process.

Depending on the starting material used by the process for the purification of whey protein isolate, a cream may be present and may thus need to be first removed (step 1). For example, this step is normally not performed for whey product starting material as these products generally have cream removed. However, in the case of colostrum, milk, and other cream-containing product starting material, the cream may be removed by any method known in the art including a de-creamer or a cream separator, or even simply letting the milk stand undisturbed so that the cream rise as a layer to the top of the milk and may be removed. While the cream is normally capable of layering to the top of colostrum and milk upon standing undisturbed, the cream can be made to layer faster upon centrifugation (e.g. at about 7,280×G-force) such that it occurs in a short period of time that is favorable to processing the milk in a commercial setting. On a large scale, a de-creamer or cream separator is generally used, while on a small scale the top-layered cream is generally skimmed off manually. The resulting solution separated from the cream is called de-creamed colostrum.

Next, the de-creamed colostrum solution is treated to remove casein therein (steps 2 and 3). To this end, the de-creamed colostrum solution is acidified to between about pH 3.9 and about pH 4.6 with an appropriate acid known in the art, such as diluted hydrochloric acid (HCl) or acetic acid, in order to precipitate casein (step 2). Preferably, 10% hydrochloric acid is used. The precipitated casein may then be removed by either filtration, settling, filter pressing or centrifugation (step 3). Preferably, the precipitated casein is filtered out from the de-creamed colostrum solution using a 1.4 μm ceramic filter under a pressure of between about 1 psi and about 14 psi, and between about 1° C. and about 20° C. Preferably, the de-creamed colostrum solution is filtered at about 8° C. and about 14 psi. During the casein removal, care most be exercised to ensure that there are no bubbles formed into the acidified whey protein isolate solution as such bubbles may be detrimental to the purification process. Following the primary clarification processing, a yellow transparent acidified whey protein solution is obtained with a yield of about 88% (w/w) (step 4).

As for the secondary separation processing, the acidified whey protein solution is first filtered with a membrane filter having a molecular weight cut-off (MWCO) between about 5 kDa and about 150 kDa (step 5), Preferably, the acidified whey protein solution is filtered with a membrane filter having a MWCO between about 80 kDa and about 150 kDa so that about 80% of the solvent contained in the acidified whey protein solution is removed. Preferentially, the membrane filter has a MWCO of about 100 kDa. This separation separate or isolate a whey protein filtrate including bovine serum albumin (BSA), beta-lactoglobulin (BLG), and alpha-lactalbumin (ALA) proteins (shown as “BSA, BLG, ALA in solution” in FIG. 1; referred to “whey protein filtrate” hereinafter) with a yield of 67%. Removed from the acidified whey protein solution are various component from the colostrum (referred to as “Ig fraction” hereinafter), such as immunoglobulins (e.g. IgG, IgA, IgM) and other proteins (e.g. lactoperoxidase and lactoferrin).

### Preparation of an Amino Acid Supplement Formulation (Steps 6 and 7)

In an embodiment, the whey protein filtrate is dehydrated (step 6), such as by spray-drying or lyophilizating, to remove residual solvent and produce a branched-chain amino acids (BCAA) fraction in the form of a dry powder (shown as “BCAA” in FIG. 1). Preferably, spray-drying is used as it is most cost-effective and the heat produced during this dehydratation process enables the breaking down of the proteins into smaller branched-chain amino acids. The BCAA fraction may be diluted and formulated (step 6), such as by the addition of a filler, such as preferably soy lecithin, to produce an amino acid supplement formulation (i.e. a whey protein isolate formulation) that has about 15% purity (shown as “WPI 15%” in FIG. 1) in a yield of about 5% (w/w).

### Purification of a Whey Protein Isolate (Steps 8 and 9)

In an embodiment, the whey protein filtrate is further filtered with a membrane filter having a MWCO between about 1 kDa and about 20 kDa (step 8) to obtain a BSA/BLG/ALA liquid fraction (shown as “BSA, BLG, ALA concentrated” in FIG. 1). Preferably, the whey protein filtrate is filtered with a membrane filter having a MWCO about 5 kDa. Then, the BSA/BLG/ALA liquid fraction is dehydrated (step 9), such as preferably by lyophilization, to remove residual solvent and produce a whey protein isolate in the form of a dry powder that has about 99% activity (shown as “WPI 99% Active” in FIG. 1). Advantageously, it has been found that the BSA, BLG, and ALA proteins obtained after this step retain about 99% of their biological activity.

### Purification of a BSA Protein Fraction (Steps 10 and 11)

In an embodiment, the whey protein filtrate is further filtered with a membrane filter having a MWCO between about 10 kDa and about 100 kDa (step 9) to obtain a BSA solid fraction (shown as “BSA concentrated” in FIG. 1), while the BLG and ALA proteins remain in the filtrate liquid fraction. Preferably, the whey protein filtrate is filtered with a membrane filter having a MWCO about 30 kDa. Then, the BSA solid fraction is dehydrated or dried (step 11), such as preferably by lyophilization, to remove residual solvent and produce a BSA protein fraction in the form of a dry powder that has 99% activity (shown as “BSA 99% Active” in FIG. 1). Advantageously, it has been found that the BSA protein obtained after this step retains about 99% of its biological activity.

### Purification of a BLG and ALA Proteins Fraction (Steps 12 and 13)

In an embodiment, the whey protein filtrate is further filtered with a membrane filter having a MWCO between about 10 kDa and about 100 kDa (step 9) to obtain a first BLG/ALA liquid fraction (shown as “BLG, ALA diluted” in FIG. 1). Preferably, the whey protein filtrate is filtered with a membrane filter having a MWCO about 30 kDa. Next, the BLG/ALA liquid fraction is again filtered with a membrane filter having a MWCO between about 1 kDa and about 20 kDa (step 12) to obtain a second BLG/ALA liquid fraction (shown as “BLG, ALA concentrated” in FIG. 1). Preferably, the second BLG/ALA liquid fraction is filtered with a membrane filter having a MWCO about 5 kDa. Then, the second BLG/ALA liquid fraction is dehydrated (step 13), such as by lyophilization, to remove residual solvent and produce BLG and ALA proteins fraction in the form of a dry powder that has 99% activity (shown as “BLG, ALA 99% Active” in FIG. 1). Advantageously, it has been found that the BLG and ALA proteins obtained after this step retain about 99% of their biological activity.

The person skilled in the art will appreciate that the present invention advantageously provides for a cost-efficient process that enables the sequential purification, isolation, and/or extraction of (i) WPI; (ii) BSA protein; (iii) BLG; and ALA proteins, while maintaining the biological activity of (i) WPI; (ii) BSA protein; (iii) BLG; and (iv) ALA proteins obtained from a starting composition produced from lactating animals, such as but not limited to milk, clostrum and lactoserum.

The person skilled in the art will further appreciate that any scientific apparatus and method may be used to monitor the identity and purity of the starting composition produced from lactating animals, such as milk's colostrum's and lactoserum's components and other chemical entities used, processed, and produced by the present purification process, such as high-performance liquid chromatography (HPLC).

It is to be noted that the purification process of whey protein isolates disclosed herein has the advantages, amongst other thing, to be highly reproduceable on a large scale and/or in an industrial setting as well as to be cost-efficient as compare to purification processes known in the art.

The present invention will be more readily understood by referring to the following examples which are given to illustrate the invention rather than to limit its scope.

### Example 1

### Chromatography Analysis of the Purification Process of Whey Protein Isolates

Chromatography analysis were conducted in order to monitor the identity and purity of some of the colostrum's components during the claimed process for the purification of whey protein isolate from colostrum.

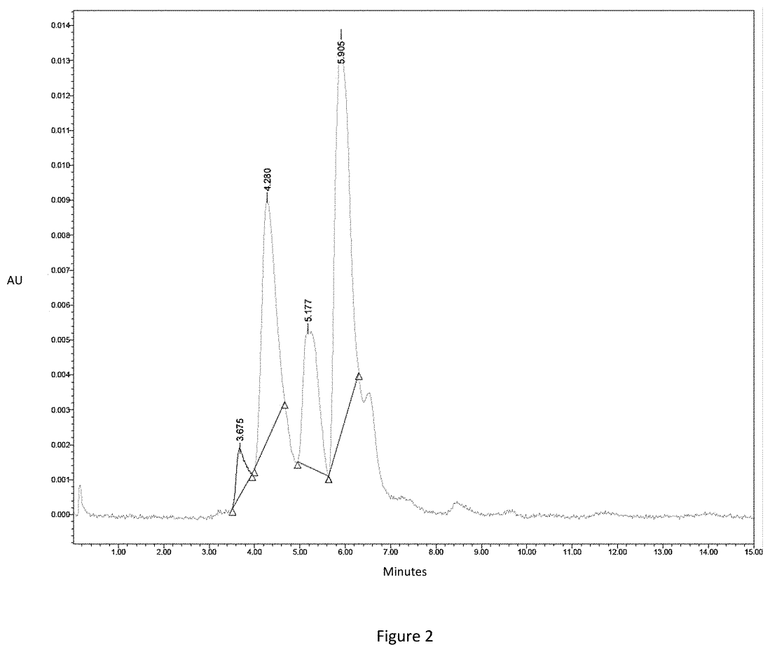

The HPLC chromatogram of FIG. 2 illustrates the elution profile of crude colostrum as starting material for the step 1 of the process for the purification of whey protein isolate. The elution profile has the following bands and associated retention time: BSA (65 kDa, tR=4.3), BLG (18.4 kDa, tR=5.15), and ALA (14.2 kDa, tR=5.9).

The HPLC chromatograms of the de-creamed colostrum obtained from step 1 and the acidified whey protein solution obtained from step 3 (both not shown) were found to have a similar elution profile as compared to the HPLC chromatogram of the crude colostrum starting material, thereby suggesting that the primary clarification processing do not alter the chemical nature and component concentrations of the crude colostrum starting material for the step 1, the de-creamed colostrum solution obtained from step 1, and the acidified whey protein isolate obtained from step 3.

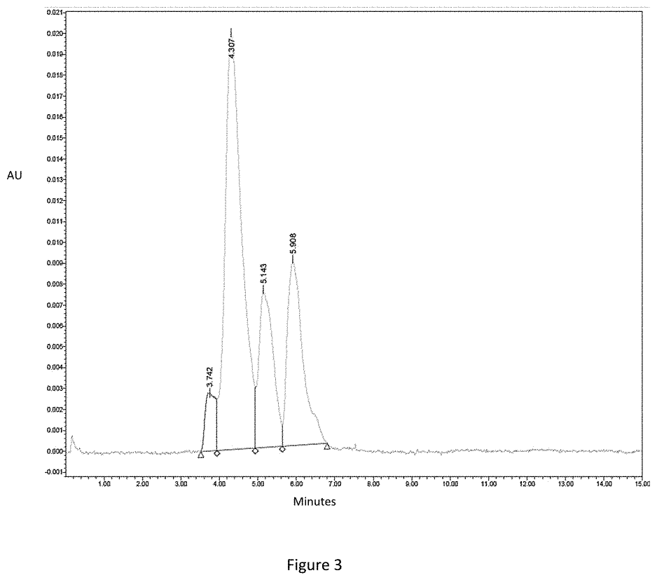

The HPLC chromatogram of FIG. 3 illustrates the elution profile of the Ig fraction obtained from step 4 filtered with a membrane filter having between about 80 kDa and about 150 kDa MWCO.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A process for the preparation of an amino acid supplement formulation, which comprises:
a) filtering a clarified whey protein solution with a filter having a molecular weight cut off between about 50 kDa and about 300 kDa to obtain a protein solution substantially free of IgA, IgG, IgM, lactoperoxidase, and lactoferrin;
b) dehydrating the protein solution to obtain a branched-chain amino acid powder; and
c) mixing the branched-chain amino acid powder with lecithin.

2. The process of claim 1, wherein the clarified whey protein solution is obtained by a clarification process, which comprises:
I. de-creaming a solution containing a composition produced from lactating animals selected from the group consisting of milk, clostrum and lactoserum;
II. acidifying the solution to between about pH 3.9 and about pH 4.6 with an acid selected from the group consisting of hydrochloric acid and acetic acid;
III. removing casein precipitate from the solution by filtration, settling, filter pressing or centrifugation; and
IV. collecting an acidified whey protein protein solution.

3. The process of claim 2, wherein the composition produced from lactating animals is frozen colostrum that is left to thaw at a temperature of about 4° C. and for a period of about 3 days.

4. The process of claim 2, wherein the acid is hydrochooric acid at a concentration about 10% and the solution is acidified to a pH of about 4.

5. The process of claim 2, wherein casein is removed from the solution by filtering through a 1.4 micrometers ceramic filter under a pressure of between about 1 psi and about 14 psi, and between about 1° C. and about 20° C.

6. An amino acid supplement formulation obtained according to claim 1 and wherein said amino acid supplement formulation having a purity of about 15%.

7. A process for the purification of a whey protein isolate, which comprises:
a) filtering a clarified whey protein solution with a filter having a molecular weight cut off between about 50 kDa and about 300 kDa to obtain a protein solution substantially free of IgA, IgG, IgM, lactoperoxidase, and lactoferrin; and
b) filtering the protein solution with a filter having a molecular weight cut off between about 1 kDa and about 20 kDa to obtain a protein solution having concentrate active albumin, beta-lactoglobulin, and alpha-lactalbum in proteins.

8. The process of claim 7, wherein the clarified whey protein solution is obtained by a clarification process, which comprises:
I. de-creaming a solution containing a composition produced from lactating animals selected from the group consisting of milk, clostrum and lactoserum;
II. acidifying the solution to between about pH 3.9 and about pH 4.6 with an acid selected from the group consisting of hydrochloric acid and acetic acid;
III. removing casein precipitate from the solution by filtration, settling, filter pressing or centrifugation; and
IV. collecting an acidified whey protein protein solution.

9. The process of claim 8, wherein the composition produced from lactating animals is frozen colostrum that is left to thaw at a temperature of about 4° C. and for a period of about 3 days.

10. The process of claim 8, wherein the acid is hydrochooric acid at a concentration about 10% and the solution is acidified to a pH of about 4.

11. The process of claim 8, wherein casein is removed from the solution by filtering through a 1.4 micrometers ceramic filter under a pressure of between about 1 psi and about 14 psi, and between about 1° C. and about 20° C.

12. The process of claim 8, wherein the albumin, beta-lactoglobulin, and alpha-lactalbumin proteins retain about 99% of their biological activity.

13. A process for the purification of a whey protein isolate, which comprises:
a) filtering a clarified whey protein solution with a filter having a molecular weight cut off between about 50 kDa and about 300 kDa to obtain a protein solution substantially free of IgA, IgG, IgM, lactoperoxidase, and lactoferrin; and
b) filtering the protein solution with a filter having a molecular weight cut off between about 10 kDa and about 100 kDa to obtain albumin protein.

14. The process of claim 13, wherein the clarified whey protein solution is obtained by a clarification process, which comprises:
I. de-creaming a solution containing a composition produced from lactating animals selected from the group consisting of milk, clostrum and lactoserum;
II. acidifying the solution to between about pH 3.9 and about pH 4.6 with an acid selected from the group consisting of hydrochloric acid and acetic acid;
III. removing casein precipitate from the solution by filtration, settling, filter pressing or centrifugation; and
IV. collecting an acidified whey protein protein solution.

15. The process of claim 14, wherein the composition produced from lactating animals is frozen colostrum that is left to thaw at a temperature of about 4° C. and for a period of about 3 days.

16. The process of claim 14, wherein the acid is hydrochooric acid at a concentration about 10% and the solution is acidified to a pH of about 4.

17. The process of claim 14, wherein casein is removed from the solution by filtering through a 1.4 micrometers ceramic filter under a pressure of between about 1 psi and about 14 psi, and between about 1° C. and about 20° C.

18. The process of claim 13, wherein the albumin protein retains about 99% of its biological activity.

19. The process of claim 7, which comprises a step c) effected after step b):
b)
c) filtering the alpha-lactalbumin and beta-lactoglobulin solution with a filter having a molecular weight cut off between about 1 kDa and about 20 kDa to obtain alpha-lactalbum in and beta-lactoglobulin proteins.

20. The process of claim 19, wherein the clarified whey protein solution is obtained by a clarification process, which comprises:
I. de-creaming a solution containing a composition produced from lactating animals selected from the group consisting of milk, colostrum and lactoserum;
II. acidifying the solution to between about pH 3.9 and about pH 4.6 with an acid selected from the group consisting of hydrochloric acid and acetic acid;
III. removing casein precipitate from the solution by filtration, settling, filter pressing or centrifugation; and
IV. collecting an acidified whey protein solution.
